(19) United States
(12) Patent Application Publication
(10) Pub. No.: US 2024/0099343 A1
(43) Pub. Date: Mar. 28, 2024

(54) USE OF GINGERDIOL COMPOUNDS TO ENHANCE FLAVOR

(71) Applicant: Firmenich SA, Satigny (CH)

(72) Inventors: Robert WAGNER, Satigny (CH); Howard MUNT, Satigny (CH)

(73) Assignee: Firmenich SA, Satigny (CH)

(21) Appl. No.: 18/263,491

(22) PCT Filed: Mar. 15, 2022
(86) PCT No.: PCT/EP2022/056673

§ 371 Date: Jul. 28, 2023

Related U.S. Application Data
(60) Provisional application No. 63/171,174, filed on Apr. 6, 2021.

(30) Foreign Application Priority Data
Apr. 14, 2021 (EP) 21168243.0

(51) Int. Cl. A23L 27/20; A23J 3/14; A23L 27/00; A23L 27/26

(52) U.S. Cl. CPC A23L 27/204; A23J 3/14; A23L 27/26; A23L 27/88

(57) ABSTRACT

The present disclosure relates to gingerdiol compounds, whether in their diol form or as a derivative, and their use to enhance the flavor of certain flavored products. In some embodiments, the flavored products have reduced amounts of salt or umami-enhancing compounds (glutamates, arginates, purinic ribonucleotides, such as inosine monophosphate (IMP) and guanosine monophosphate (GMP)), relative to comparable flavored products that do not incorporate the gingerol compounds. In some embodiments, the flavored products contain non-animal proteins, such as plant proteins, mycoproteins, algal proteins, and the like.

### TECHNICAL FIELD

The present disclosure relates to gingerdiol compounds, whether in their diol form or as a derivative, and their use to enhance the flavor of certain flavored products. In some embodiments, the flavored products have reduced amounts of salt or umami-enhancing compounds (glutamates, arginates, purinic ribonucleotides, such as inosine monophosphate (IMP) and guanosine monophosphate (GMP)), relative to comparable flavored products that do not incorporate the gingerol compounds. In some embodiments, the flavored products contain non-animal proteins, such as plant proteins, mycoproteins, algal proteins, and the like.

### DESCRIPTION OF RELATED ART

Table salt is a commonly used compound for eliciting the perception of salty taste in ingestible products, and has many desirable culinary properties to improve the sensory properties of food products and to enhance the positive sensory attributes of foods to taste better. Reduced sodium food may not taste good for people who are accustomed to high levels of salt in their food. Salt levels in food products may be reduced by understanding the flavor-enhancing properties and flavor perception of salts. The development of salt substitutes or enhancers can contribute to a reduction of salt in food products by understanding how salt is detected by sensory receptors. The taste of salt can also encompass the larger concept of flavor. The sense of taste is composed of a small number of primary or basic taste qualities, such as sweet, sour, salty, bitter, and savory or umami. Sodium chloride is the prototypical salt taste molecule imparting an almost pure salt taste. A critical attribute of salt taste is its hedonic or pleasantness dimension to overall food flavor. Salt was found to improve the perception of product thickness, enhance sweetness, mask metallic or chemical off-notes, and round out overall flavor while improving flavor intensity.

It is generally believed that the cations of salts serve as the agents for imparting the perceptual taste component, while the anions, in addition to contributing to tastes of their own, modify the perception of the taste of the cations. By way of example, sodium and lithium are believed to impart only salty tastes, while potassium and other alkaline earth cations produce both salty and bitter tastes. Among the anions commonly found in foods, the chloride ion is considered to be the least inhibitory to the salty taste, while the citrate anion is more inhibitory.

Sodium chloride imparts an almost pure salt taste. Attempts have been made to provide salty tasting compositions as a substitute for sodium chloride to give the same or a similar seasoning effect. Potassium chloride is often used in lowered-sodium formulations. However, potassium chloride tastes both salty and bitter, and this bitterness is a concern in replacing the sensory effects of sodium chloride. Ammonium chloride and other similar compounds have a bitter aftertaste. Neither of these compounds individually or in combination positively affects other taste modalities and tastes like sodium chloride.

Salty taste is especially desired in meaty and meat-like products. Such meat-like products include meat analogues, which contain non-animal proteins, and certain food foods, such as mushrooms, that impart a meaty taste and texture. In many instances, such food products may contain ingredients that impart certain bitter notes or unpleasant notes, which may be partially masked by adding more salt. But, as noted above, increasing the salt content is often undesirable.

Thus, there is a continuing need to discover new compounds, compositions, and methods to modify or enhance the salty taste of the food products while using less salt, especially in the context of various non-meat savory products.

### SUMMARY

The present disclosure provides uses of certain gingerol compounds to enhance the flavor of meat-like products, such as meat analogues, mushroom-based products, and the like.

In a first aspect, the disclosure provides uses of a flavor-modifying compound to enhance a salty taste of a meat-like product, wherein the flavor-modifying compound is a compound of formula (I)

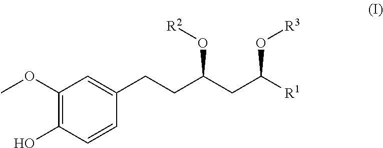

or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the meat-like product is a mushroom-containing product, such as a mushroom soup. In some embodiments, the meat-like product is a meat analogue product, which contains one or more non-animal proteins. In a related aspect, the disclosure provides corresponding methods of enhancing a salty taste of a meat-like product comprising introducing the flavor-modifying compound to a meat-like product.

In a second aspect, the disclosure provides uses of a flavor-modifying compound to enhance an umami taste of a meat-like product, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the meat-like product is a mushroom-containing product, such as a mushroom soup. In some embodiments, the meat-like product is a meat analogue product, which contains one or more non-animal proteins. In a related aspect, the disclosure provides corresponding methods of enhancing an umami taste of a meat-like product comprising introducing the flavor-modifying compound to a meat-like product.

In a third aspect, the disclosure provides uses of a flavor-modifying compound to enhance a kokumi taste of a meat-like product, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the meat-like product is a mushroom-containing product, such as a mushroom soup. In some embodiments, the meat-like product is a meat analogue product, which contains one or more non-animal proteins. In a related aspect, the disclosure provides corresponding methods of enhancing a kokumi taste of a meat-like product comprising introducing the flavor-modifying compound to a meat-like product.

In a fourth aspect, the disclosure provides uses of a flavor-modifying compound to enhance a perceived juiciness of a meat-like product, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the meat-like product is a mushroom-containing product, such as a mushroom soup. In some embodiments, the meat-like product is a meat analogue product, which contains one or more non-animal proteins. In a related aspect, the disclosure provides corresponding methods of enhancing a perceived juiciness of a meat-like product comprising introducing the flavor-modifying compound to a meat-like product.

In a fifth aspect, the disclosure provides uses of a flavor-modifying compound to enhance a perceived fattiness of a meat-like product, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the meat-like product is a mushroom-containing product, such as a mushroom soup. In some embodiments, the meat-like product is a meat analogue product, which contains one or more non-animal proteins. In a related aspect, the disclosure provides corresponding methods of enhancing a perceived fattiness of a meat-like product comprising introducing the flavor-modifying compound to a meat-like product.

In a sixth aspect, the disclosure provides uses of a flavor-modifying compound to reduce an amount of a salty tastant in a meat-like product, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the meat-like product is a mushroom-containing product, such as a mushroom soup. In some embodiments, the meat-like product is a meat analogue product, which contains one or more non-animal proteins. In some embodiments, the salty tastant is sodium chloride. In a related aspect, the disclosure provides corresponding methods of reducing an amount of salty tastant in a meat-like product comprising introducing the flavor-modifying compound to a meat-like product.

In a seventh aspect, the disclosure provides uses of a flavor-modifying compound to reduce an amount of an umami tastant in a meat-like product, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the meat-like product is a mushroom-containing product, such as a mushroom soup. In some embodiments, the meat-like product is a meat analogue product, which contains one or more non-animal proteins. In some embodiments, the umami tastant is a glutamate, an arginate, or a purinic ribonucleotide, such as inosine monophosphate (IMP) or guanosine monophosphate (GMP). In a related aspect, the disclosure provides corresponding methods of reducing an amount of an umami tastant in a meat-like product comprising introducing the flavor-modifying compound to a meat-like product.

In an eighth aspect, the disclosure provides uses of a flavor-modifying compound to reduce an amount of a kokumi tastant in a meat-like product, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the meat-like product is a mushroom-containing product, such as a mushroom soup. In some embodiments, the meat-like product is a meat analogue product, which contains one or more non-animal proteins. In some embodiments, the kokumi tastant is a yeast extract, a fermented food product, cheese, garlic or extracts thereof, a gamma-glutamyl-containing polypeptide, a gamma-glutamyl-containing oligopeptide (such as gamma-glutamyl-containing tripeptides); an amide compound (such as a cinnamic acid amide or a derivative thereof), a nucleotide, an oligonucleotide, a plant extract, or a food extract. In a related aspect, the disclosure provides corresponding methods of reducing an amount of a kokumi tastant in a meat-like product comprising introducing the flavor-modifying compound to a meat-like product.

In a ninth aspect, the disclosure provides uses of a flavor-modifying compound to reduce an amount of dietary fat in a meat-like product, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the meat-like product is a mushroom-containing product, such as a mushroom soup. In some embodiments, the meat-like product is a meat analogue product, which contains one or more non-animal proteins. In some embodiments, the dietary fat is an animal-derived fat, such as triglycerides containing stearic acid or palmitic acid residues, which are derived from beef, pork, poultry, and the like. In some other embodiments, the dietary fat is a non-animal fat, for example, a plant-derived fat such as oils derived from olive, cocoa, coconut, palm kernel, palm, canola, sunflower, safflower, soybean, corn, cottonseed, peanut, sesame, almond, cashew, flaxseed, hemp, and the like. In a related aspect, the disclosure provides corresponding methods of reducing an amount of a kokumi tastant in a meat-like product comprising introducing the flavor-modifying compound to a meat-like product.

In a tenth aspect, the disclosure provides uses of a flavor-modifying compound to reduce an amount of animal products in a meat-like product, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the meat-like product is a mushroom-containing product, such as a mushroom soup. In some embodiments, the meat-like product is a meat analogue product, which contains one or more non-animal proteins. In some embodiments, the animal product is meat, meat broth, animal-derived proteins, and the like. In a related aspect, the disclosure provides corresponding methods of reducing an amount of animal products in a meat-like product comprising introducing the flavor-modifying compound to a meat-like product.

In an eleventh aspect, the disclosure provides uses of a flavor-modifying compound to reduce an amount of alcohol in a comestible product, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the comestible product is a beverage product, such as a low-alcohol or alcohol-free beverage product, including, but not limited to, a low-alcohol beer, an alcohol-free beer, a low-alcohol flavored seltzer beverage, or an alcohol-free seltzer beverage. In other embodiments, the comestible product is a food product, such as a confectionary product or a candy product. In a related aspect, the disclosure provides corresponding methods of reducing an amount of alcohol in a comestible product comprising introducing the flavor-modifying compound to a comestible product.

In a twelfth aspect, the disclosure provides a meat-like food product comprising a flavor-modifying compound, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the meat-like product is a mushroom-containing product, such as a mushroom soup. In some embodiments, the meat-like product is a meat analogue product, which contains one or more non-animal proteins. In some embodiments, the meat-like product further comprises a salty tastant, an umami tastant, a kokumi tastant, or any combination thereof. In some embodiments, the meat-like product further comprises a non-animal fat, a non-animal protein, a non-animal fiber, or any combinations thereof. In some embodiments, the meat-like product comprises a non-animal fat, which is comprised by the oil phase of an oil-in-water emulsion or a water-in-oil emulsion.

In a thirteenth aspect, the disclosure provides a low-alcohol or alcohol-free beverage product comprising a flavor-modifying compound, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the low-alcohol or alcohol-free beverage product is a low-alcohol beer, an alcohol-free beer, a low-alcohol flavored seltzer beverage, or an alcohol-free seltzer beverage. In some embodiments, the low-alcohol or alcohol-free beverage product further comprises a salty tastant, an umami tastant, a kokumi tastant, or any combination thereof. In some further embodiments, the low-alcohol or alcohol-free beverage product comprises one or more flavorings.

In a fourteenth aspect, the disclosure provides a confectionary or candy product comprising a flavor-modifying compound, wherein the flavor-modifying compound is a compound of formula (I) (as set forth above) or a comestibly acceptable salt thereof, wherein: R¹ is C₁₋₁₂ alkyl; and R² and R³ are, independently from each other, a hydrogen atom, —C(O)—H, or —C(O)—(C₁₋₆ alkyl). In some embodiments, R¹ is pentyl, heptyl, or nonyl. In some embodiments, R² and R³ are both a hydrogen atom. In some embodiments, the confectionary product or candy product further comprises a salty tastant, an umami tastant, a kokumi tastant, or any combination thereof. In some further embodiments, the low-alcohol or alcohol-free beverage product comprises one or more flavorings, such as a chocolate flavoring.

Further aspects and embodiments of the present disclosure are set forth in the Detailed Description, Examples, and Drawings.

### BRIEF DESCRIPTION OF THE DRAWINGS

The following drawings are provided for purposes of illustrating various embodiments of the compositions and methods disclosed herein. The drawings are provided for illustrative purposes only, and are not intended to describe any preferred compositions or preferred methods, or to serve as a source of any limitations on the scope of the claimed inventions.

FIG. 1 shows a flavor-modifying compound for which certain uses are disclosed herein, wherein R¹ is C₁₋₁₂ alkyl; and R² and R³ are, independently from each other, a hydrogen atom, —C(O)—H, or —C(O)—(C₁₋₆ alkyl).

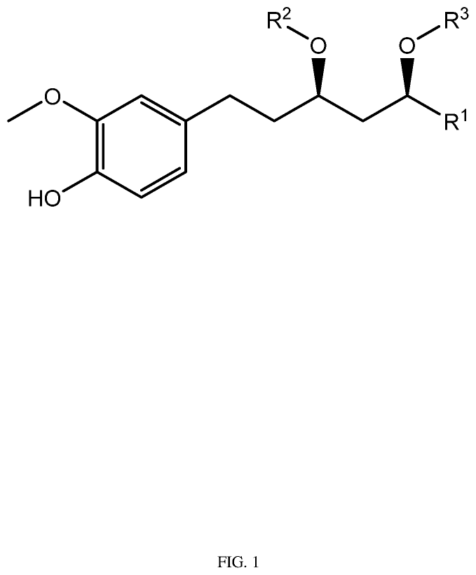

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary

As used herein, “Cₐ to C_{b}” or “Cₐ-b” in which “a” and “b” are integers, refer to the number of carbon atoms in the specified group. That is, the group can contain from “a” to “b”, inclusive, carbon atoms. Thus, for example, a “C₁ to C₄ alkyl” or “C₁₋₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂—, CH₃CH₂CH(CH₃)— and (CH₃)₃C—.

As used herein, “alkyl” means a straight or branched hydrocarbon chain that is fully saturated (i.e., contains no double or triple bonds). In some embodiments, an alkyl group has 1 to 20 carbon atoms (whenever it appears herein, a numerical range such as “1 to 20” refers to each integer in the given range; e.g., “1 to 20 carbon atoms” means that the alkyl group may consist of 1 carbon atom, 2 carbon atoms, 3 carbon atoms, etc., up to and including 20 carbon atoms, although the present definition also covers the occurrence of the term “alkyl” where no numerical range is designated). The alkyl group may also be a medium size alkyl having 1 to 9 carbon atoms. The alkyl group could also be a lower alkyl having 1 to 4 carbon atoms. The alkyl group may be designated as “C₁₋₄ alkyl” or similar designations. By way of example only, “C₁₋₄ alkyl” indicates that there are one to four carbon atoms in the alkyl chain, i.e., the alkyl chain is selected from the group consisting of methyl, ethyl, propyl, iso-propyl, n-butyl, iso-butyl, sec-butyl, and t-butyl. Typical alkyl groups include, but are in no way limited to, methyl, ethyl, propyl, isopropyl, butyl, isobutyl, tertiary butyl, pentyl, hexyl, and the like. Unless indicated to the contrary, the term “alkyl” refers to a group that is not further substituted. Note that, as used herein, terms such as “pentyl,” “heptyl,” and “nonyl” refer to the straight chain radicals, and are equivalent to the terms n-pentyl, n-heptyl, and n-nonyl, respectively.

It is to be understood that certain radical naming conventions can include either a mono-radical or a di-radical, depending on the context. For example, where a substituent requires two points of attachment to the rest of the molecule, it is understood that the substituent is a di-radical. For example, a substituent identified as alkyl that requires two points of attachment includes di-radicals such as —CH₂—, —CH₂CH₂—, —CH₂CH(CH₃)CH₂—, and the like.

Wherever a substituent is depicted as a di-radical (i.e., has two points of attachment to the rest of the molecule), it is to be understood that the substituent can be attached in any directional configuration unless otherwise indicated. Thus, for example, a substituent depicted as -AE- or

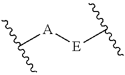

includes the substituent being oriented such that the A is attached at the leftmost attachment point of the molecule as well as the case in which A is attached at the rightmost attachment point of the molecule.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A₁ and A₂, then one or more members of the class can be present concurrently.

As used herein, certain substituents or linking groups having only a single atom may be referred to by the name of the atom. For example, in some cases, the substituent “—H” may be referred to as “hydrogen” or “a hydrogen atom,” the substituent “—F” may be referred to as “fluorine” or “a fluorine atom,” and the linking group “—O—” may be referred to as “oxygen” or “an oxygen atom.”

Points of attachment for groups are generally indicated by a terminal dash (-) or by an asterisk (*). For example, a group such as *—CH₂—CH₃ or —CH₂—CH₃ both represent an ethyl group.

Chemical structures are often shown using the “skeletal” format, such that carbon atoms are not explicitly shown, and hydrogen atoms attached to carbon atoms are omitted entirely. For example, the structure

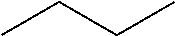

represents butane (i.e., n-butane). Furthermore, aromatic groups, such as benzene, are represented by showing one of the contributing resonance structures. For example, the structure

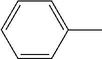

represents toluene.

As used herein, the term “gingerdiol compound” refers to compounds of formula (I), or comestibly acceptable salts thereof, or any generic or specific embodiments thereof.

As used herein a “salty tastant” is a compound that, when ingested, (i) elicits or enhances a perception of salty taste alone or in the presence of a salt, such as sodium chloride or (ii) alters the flow of ions through one or more ion channel associated with perception of salty taste. Examples of ion channels associated with the perception of salty taste include the ENaC channel, the TrpV1 channel and the TrpML3 channel. The term “enhance salty taste” refers to increasing the perception of the presence of a salty tastant, while directly contributing only secondarily (or not at all) to salty taste.

As used herein an “umami tastant” is a compound that, when ingested, (i) elicits or enhances a perception of an umami taste alone or in the presence of another umami tastant or (ii) activates the T1R umami taste receptor. The term “enhance umami taste” refers to increasing the perception of the presence of an umami tastant, while directly contributing only secondarily (or not at all) to umami taste.

As used herein a “kokumi tastant” is a compound that, when ingested, elicits or enhances a perception of a kokumi taste alone or in the presence of another kokumi tastant. The term “enhance kokumi taste” refers to increasing the perception of the presence of a kokumi tastant, while directly contributing only secondarily (or not at all) to kokumi taste.

As used herein, “juiciness” refers to the presence of liquids, such as water and liquid fat, within a product. The term “enhance perceived juiciness” refers to increasing the perception of the presence of liquid within a product without actually increasing the amount of liquid in the product. For example, compounds that induce increased saliva production can enhance the perception of juiciness.

As used herein, “fattiness” refers to the presence of fatty acid glycerides (for example, triglycerides) within a product. The term “enhance perceived fattiness” refers to increasing the perception of the presence of fatty acid glycerides within a product without actually increasing the amount of fatty acid glycerides in the product.

Other terms are defined in other portions of this description, even though not included in this subsection.

### Gingerdiol Compounds

In various aspects set forth herein, the disclosed uses, methods, pr products employ gingerdiol flavor-modifying compounds, which are compounds of formula (I)

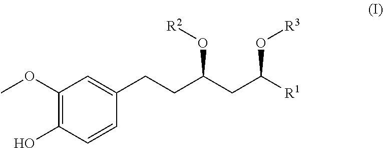

or a comestibly acceptable salts thereof, wherein: R¹ is C₁₋₁₂ alkyl; and R² and R³ are, independently from each other, a hydrogen atom, —C(O)—H, or —C(O)—(C₁₋₆ alkyl).

The variable R¹ can have any suitable value consistent with the definitions set forth above. In some embodiments, R₁ is C₁₋₁₀ alkyl. In some embodiments, R¹ is pentyl. In some embodiments, R¹ is heptyl. In some embodiments, R¹ is nonyl. In some embodiments, R¹ is undecyl.

The variables R² and R³ can have any suitable values consistent with the definition set forth above. In some embodiments, R² and R³ are both a hydrogen atom. In some embodiments, one of R² and R³ is a hydrogen atom and the other is —C(O)—(C₁₋₄ alkyl), such as —C(O)—CH₃. In some embodiments, both of R² and R³ —C(O)—(C₁₋₄ alkyl), such as both are —C(O)—CH₃.

In some embodiments, when R¹ is pentyl, R² and R³ are not both —C(O)—CH₃. In some embodiments, when R¹ is pentyl, both R² and R³ are a hydrogen atom.

In some embodiments, the compound of formula (I) is [8]-gingerdioldiacetate, [10]-gingerdioldiacetate, [6]-gingerdiol, [8]-gingerdiol, or [10]-gingerdiol. In some embodiments, the compound of formula (I) is [6]-gingerdioldiacetate, [8]-gingerdioldiacetate, [10]-gingerdioldiacetate, [6]-gingerdiol, [8]-gingerdiol, or [10]-gingerdiol. In some embodiments, the compound of formula (I) is [8]-gingerdioldiacetate or [10]-gingerdioldiacetate. In some embodiments, the compound of formula (I) is [6]-gingerdiol, [8]-gingerdiol, or [10]-gingerdiol.

Where the compounds disclosed herein have at least one chiral center that is not specifically indicated in the formula, they may exist as individual enantiomers and diastereomers or as mixtures of such isomers. In some embodiments in connection with the second aspect, the sweet-enhancing compound has substantial enantiomeric purity.

Separation of the individual isomers or selective synthesis of the individual isomers is accomplished by application of various methods which are well known to practitioners in the art. Unless otherwise indicated (e.g., where the stereochemistry of a chiral center is explicitly shown), all such isomers and mixtures thereof are included in the scope of the compounds disclosed herein. Furthermore, compounds disclosed herein may exist in one or more crystalline or amorphous forms. Unless otherwise indicated, all such forms are included in the scope of the compounds disclosed herein including any polymorphic forms. In addition, some of the compounds disclosed herein may form solvates with water (i.e., hydrates) or common organic solvents. Unless otherwise indicated, such solvates are included in the scope of the compounds disclosed herein.

The skilled artisan will recognize that some structures described herein may be resonance forms or tautomers of compounds that may be fairly represented by other chemical structures, even when kinetically; the artisan recognizes that such structures may only represent a very small portion of a sample of such compound(s). Such compounds are considered within the scope of the structures depicted, though such resonance forms or tautomers are not represented herein.

Isotopes may be present in the compounds described. Each chemical element as represented in a compound structure may include any isotope of said element. For example, in a compound structure a hydrogen atom may be explicitly disclosed or understood to be present in the compound. At any position of the compound that a hydrogen atom may be present, the hydrogen atom can be any isotope of hydrogen, including but not limited to hydrogen-1 (protium) and hydrogen-2 (deuterium). Thus, reference herein to a compound encompasses all potential isotopic forms unless the context clearly dictates otherwise.

In some embodiments, the compounds disclosed herein are capable of forming acid and/or base salts by virtue of the presence of amino and/or carboxyl groups or groups similar thereto. To the extent that such salts are safe for animal consumption (e.g., human consumption), they are referred to as “comestibly acceptable salts.” Comestibly acceptable acid addition salts can be formed with inorganic acids and organic acids. Inorganic acids from which salts can be derived include, for example, hydrochloric acid, hydrobromic acid, sulfuric acid, nitric acid, phosphoric acid, and the like. Organic acids from which salts can be derived include, for example, acetic acid, propionic acid, glycolic acid, pyruvic acid, oxalic acid, maleic acid, malonic acid, succinic acid, fumaric acid, tartaric acid, citric acid, benzoic acid, cinnamic acid, mandelic acid, methanesulfonic acid, ethanesulfonic acid, p-toluenesulfonic acid, salicylic acid, and the like. Physiologically acceptable salts can be formed using inorganic and organic bases. Inorganic bases from which salts can be derived include, for example, bases that contain sodium, potassium, lithium, ammonium, calcium, magnesium, iron, zinc, copper, manganese, aluminum, and the like; particularly preferred are the ammonium, potassium, sodium, calcium and magnesium salts. In some embodiments, treatment of the compounds disclosed herein with an inorganic base results in loss of a labile hydrogen from the compound to afford the salt form including an inorganic cation such as Li⁺, Na⁺, K⁺, Mg²⁺ and Ca²⁺ and the like. Organic bases from which salts can be derived include, for example, primary, secondary, and tertiary amines, substituted amines including naturally occurring substituted amines, cyclic amines, basic ion exchange resins, and the like, specifically such as isopropylamine, trimethylamine, diethylamine, triethylamine, tripropylamine, and ethanolamine.

### Uses and Methods,

In other aspects, the disclosure provides formulations, uses, and methods of using the gingerdiol compounds of formula (I) or their comestibly acceptable salts (in any form according to the preceding aspects and embodiments thereof).

In certain aspects, the disclosure provides uses of any gingerdiol compounds of the preceding aspects or embodiments.

In certain aspects, the disclosure provides uses of a flavor-modifying compound to enhance a salty taste of a meat-like product, wherein the flavor-modifying compound is a compound of formula (I) or a comestibly acceptable salt thereof (according to any of the embodiments set forth above). In a related aspect, the disclosure provides corresponding methods of enhancing a salty taste of a meat-like product comprising introducing the aforementioned gingerdiol flavor-modifying compound to a meat-like product.

In certain aspects, the disclosure provides uses of a flavor-modifying compound to enhance an umami taste of a meat-like product, wherein the flavor-modifying compound is a compound of formula (I) or a comestibly acceptable salt thereof (according to any of the embodiments set forth above). In a related aspect, the disclosure provides corresponding methods of enhancing an umami taste of a meat-like product comprising introducing the aforementioned gingerdiol flavor-modifying compound to a meat-like product.

In certain aspects, the disclosure provides uses of a flavor-modifying compound to enhance a kokumi taste of a meat-like product, wherein the flavor-modifying compound is a compound of formula (I) or a comestibly acceptable salt thereof (according to any of the embodiments set forth above). In a related aspect, the disclosure provides corresponding methods of enhancing a kokumi taste of a meat-like product comprising introducing the aforementioned gingerdiol flavor-modifying compound to a meat-like product.

In certain aspects, the disclosure provides uses of a flavor-modifying compound to enhance a perceived juiciness of a meat-like product, wherein the flavor-modifying compound is a compound of formula (I) or a comestibly acceptable salt thereof (according to any of the embodiments set forth above). In a related aspect, the disclosure provides corresponding methods of enhancing a perceived juiciness of a meat-like product comprising introducing the aforementioned gingerdiol flavor-modifying compound to a meat-like product.

In certain aspects, the disclosure provides uses of a flavor-modifying compound to enhance a perceived fattiness of a meat-like product, wherein the flavor-modifying compound is a compound of formula (I) or a comestibly acceptable salt thereof (according to any of the embodiments set forth above). In a related aspect, the disclosure provides corresponding methods of enhancing a perceived fattiness of a meat-like product comprising introducing the aforementioned gingerdiol flavor-modifying compound to a meat-like product.

In certain aspects, the gingerdiol flavor-modifying compounds disclosed herein can be used to compensate for a decreased amount of certain palatable ingredients in a product. For example, such compounds that enhance salty taste can be included in lieu of a certain amount of salt (e.g., sodium chloride) in the product. Thus, one may be able to reduce the salt content in the product without any material diminution of the salty taste of the product.

Thus, in certain aspects, the disclosure provides uses of a flavor-modifying compound to reduce an amount of a salty tastant in a meat-like product, wherein the flavor-modifying compound is a compound of formula (I) or a comestibly acceptable salt thereof (according to any of the embodiments set forth above). In some embodiments, the salty tastant is sodium chloride, potassium chloride, or a combination thereof. In some embodiments, the salty tastant is sodium chloride. In some embodiments, the presence of the gingerdiol flavor-modifying compound in the meat-like product allows one to reduce the concentration of the salty tastant in the meat-like product by from 5% to 20%, or from 5% to 30%, or from 5% to 40%, or from 5% to 50%, or from 5% to 60%, or from 5% to 70%, or from 5% to 80%, or from 5% to 90%, and have a product that has a similar salty taste to a comparable product without the gingerdiol flavor-modifying compound and a standard concentration of salty tastant. In some embodiments, the presence of the gingerdiol flavor-modifying compound in the meat-like product allows one to eliminate entirely or substantially eliminate (for example, reduce by at least 95%, or by at least 97%, or by at least 99%) a salty tastant, and have a product that has a similar salty taste to a comparable product without the gingerdiol flavor-modifying compound and a standard concentration of salty tastant. In a related aspect, the disclosure provides corresponding methods of reducing an amount of salty tastant in a meat-like product comprising introducing the flavor-modifying compound to a meat-like product.

In certain aspects, the disclosure provides uses of a flavor-modifying compound to reduce an amount of an umami tastant in a meat-like product, wherein the flavor-modifying compound is a compound of formula (I) or a comestibly acceptable salt thereof (according to any of the embodiments set forth above). In some embodiments, the umami tastant is a glutamate (such as monosodium glutamate), an arginate, or a purinic ribonucleotide, such as inosine monophosphate (IMP) or guanosine monophosphate (GMP), or any combination thereof. In some embodiments, the umami tastant is monosodium glutamate (MSG). In some embodiments, the presence of the gingerdiol flavor-modifying compound in the meat-like product allows one to reduce the concentration of the umami tastant in the meat-like product by from 5% to 20%, or from 5% to 30%, or from 5% to 40%, or from 5% to 50%, or from 5% to 60%, or from 5% to 70%, or from 5% to 80%, or from 5% to 90%, and have a product that has a similar salty taste to a comparable product without the gingerdiol flavor-modifying compound and a standard concentration of umami tastant. In some embodiments, the presence of the gingerdiol flavor-modifying compound in the meat-like product allows one to eliminate entirely or substantially eliminate (for example, reduce by at least 95%, or by at least 97%, or by at least 99%) the umami tastant, and have a product that has a similar umami taste to a comparable product without the gingerdiol flavor-modifying compound and a standard concentration of umami tastant. In a related aspect, the disclosure provides corresponding methods of reducing an amount of umami tastant in a meat-like product comprising introducing the flavor-modifying compound to a meat-like product.

In certain aspects, the disclosure provides uses of a flavor-modifying compound to reduce an amount of a kokumi tastant in a meat-like product, wherein the flavor-modifying compound is a compound of formula (I) or a comestibly acceptable salt thereof (according to any of the embodiments set forth above). In some embodiments, the kokumi tastant is a yeast extract, a fermented food product, cheese, garlic or extracts thereof, a gamma-glutamyl-containing polypeptide, a gamma-glutamyl-containing oligopeptide (such as gamma-glutamyl-containing tripeptides); an amide compound (such as a cinnamic acid amide or a derivative thereof), a nucleotide, an oligonucleotide, a plant extract, or a food extract, or any combination thereof. In some embodiments, the kokumi tastant is a gamma-glutamyl-containing tripeptide. In some embodiments, the presence of the gingerdiol flavor-modifying compound in the meat-like product allows one to reduce the concentration of the kokumi tastant in the meat-like product by from 5% to 20%, or from 5% to 30%, or from 5% to 40%, or from 5% to 50%, or from 5% to 60%, or from 5% to 70%, or from 5% to 80%, or from 5% to 90%, and have a product that has a similar kokumi taste to a comparable product without the gingerdiol flavor-modifying compound and a standard concentration of the kokumi tastant. In some embodiments, the presence of the gingerdiol flavor-modifying compound in the meat-like product allows one to eliminate entirely or substantially eliminate (for example, reduce by at least 95%, or by at least 97%, or by at least 99%) a kokumi tastant, and have a product that has a similar kokumi taste to a comparable product without the gingerdiol flavor-modifying compound and a standard concentration of the kokumi tastant. In a related aspect, the disclosure provides corresponding methods of reducing an amount of kokumi tastant in a meat-like product comprising introducing the flavor-modifying compound to a meat-like product.

In certain aspects, the disclosure provides uses of a flavor-modifying compound to reduce an amount of dietary fat in a meat-like product, wherein the flavor-modifying compound is a compound of formula (I) or a comestibly acceptable salt thereof (according to any of the embodiments set forth above). In some embodiments, the dietary fat is an animal-derived fat, such as triglycerides containing stearic acid or palmitic acid residues, which are derived from beef, pork, poultry, and the like. In some other embodiments, the dietary fat is a non-animal fat, for example, a plant-derived fat such as oils derived from olive, cocoa, coconut, palm kernel, palm, canola, sunflower, safflower, soybean, corn, cottonseed, peanut, sesame, almond, cashew, flaxseed, hemp, and the like. In some embodiments, the presence of the gingerdiol flavor-modifying compound in the meat-like product allows one to reduce the concentration of dietary fat in the meat-like product by from 5% to 20%, or from 5% to 30%, or from 5% to 40%, or from 5% to 50%, or from 5% to 60%, or from 5% to 70%, or from 5% to 80%, or from 5% to 90%, and have a product that has a similar perceived fattiness or perceived juiciness to a comparable product without the gingerdiol flavor-modifying compound and a standard concentration of dietary fat. In some embodiments, the presence of the gingerdiol flavor-modifying compound in the meat-like product allows one to eliminate entirely or substantially eliminate (for example, reduce by at least 95%, or by at least 97%, or by at least 99%) dietary fat, and have a product that has a similar perceived juiciness or perceived fattiness to a comparable product without the gingerdiol flavor-modifying compound and a standard concentration of dietary fat. In a related aspect, the disclosure provides corresponding methods of reducing an amount of dietary fat in a meat-like product comprising introducing the flavor-modifying compound to a meat-like product.

In certain aspects, the disclosure provides uses of a flavor-modifying compound to reduce an amount of animal products in a meat-like product, wherein the flavor-modifying compound is a compound of formula (I) or a comestibly acceptable salt thereof (according to any of the embodiments set forth above). In some embodiments, the animal product is meat, meat broth, animal-derived proteins, and the like. In some embodiments, the presence of the gingerdiol flavor-modifying compound in the meat-like product allows one to reduce the concentration of animal product in the meat-like product by from 5% to 20%, or from 5% to 30%, or from 5% to 40%, or from 5% to 50%, or from 5% to 60%, or from 5% to 70%, or from 5% to 80%, or from 5% to 90%, and have a product that has a similar perceived fattiness or perceived juiciness to a comparable product without the gingerdiol flavor-modifying compound and a standard concentration of animal product. In some embodiments, the presence of the gingerdiol flavor-modifying compound in the meat-like product allows one to eliminate entirely or substantially eliminate (for example, reduce by at least 95%, or by at least 97%, or by at least 99%) animal products, and have a product that has a similar perceived juiciness or perceived fattiness to a comparable product without the gingerdiol flavor-modifying compound and a standard concentration of animal product. In a related aspect, the disclosure provides corresponding methods of reducing an amount of animal product in a meat-like product comprising introducing the flavor-modifying compound to a meat-like product.

In certain aspects, the disclosure provides uses of a flavor-modifying compound to reduce an amount of alcohol in a comestible product, wherein the flavor-modifying compound is a compound of formula (I) or a comestibly acceptable salt thereof (according to any of the embodiments set forth above). In some embodiments, the comestible product is a beverage product, such as a low-alcohol or alcohol-free beverage product, including, but not limited to, a low-alcohol beer, an alcohol-free beer, a low-alcohol flavored seltzer beverage, or an alcohol-free seltzer beverage. In other embodiments, the comestible product is a food product, such as a confectionary product or a candy product. In some embodiments, the presence of the gingerdiol flavor-modifying compound in the comestible product allows one to reduce the concentration of alcohol in the comestible product by from 5% to 20%, or from 5% to 30%, or from 5% to 40%, or from 5% to 50%, or from 5% to 60%, or from 5% to 70%, or from 5% to 80%, or from 5% to 90%, and have a product that has a similar perceived alcoholic content to a comparable product without the gingerdiol flavor-modifying compound and a standard concentration of alcohol. In some embodiments, the presence of the gingerdiol flavor-modifying compound in the comestible product allows one to eliminate entirely or substantially eliminate (for example, reduce by at least 95%, or by at least 97%, or by at least 99%) alcohol, and have a product that has a similar perceived alcoholic content to a comparable product without the gingerdiol flavor-modifying compound and a standard concentration of alcohol. In a related aspect, the disclosure provides corresponding methods of reducing an amount of alcohol in a comestible product comprising introducing the flavor-modifying compound to a comestible product.

### Meat-Like Products

Several of the preceding uses and methods make reference to meat-like products in which the gingerdiol flavor-modifying compounds are included or incorporated.

In certain aspects, such meat-like food products comprising a flavor-modifying compound, wherein the flavor-modifying compound is a compound of formula (I) or a comestibly acceptable salt thereof (according to any of the embodiments set forth above)

In some embodiments, the meat-like product is a mushroom-containing product, which comprises mushrooms. Any suitable type of comestible mushroom or combination of comestible mushrooms can be used, including, but not limited to, button mushrooms, cremini mushrooms, portobello mushrooms, oyster mushrooms, king oyster mushrooms, chanterelle mushrooms, porcini mushrooms, hedgehog mushrooms, chicken of the woods mushrooms, black trumpet mushrooms, wood blewit mushrooms, morel mushrooms, enoki mushrooms, shimeji mushrooms, shiitake mushrooms, maitake mushrooms, reishi mushrooms, lion's mane mushrooms, matsutake mushrooms, giant puffball mushrooms, black truffles, white truffles, burgundy truffles, and garlic truffles.

In some such embodiments, the mushroom-containing product is a soup, which may contain additional ingredients as set forth below. In some embodiments, the soup is a clear soup. In other embodiments, the soup is a cream soup. In some other embodiments, the mushroom-containing product is a meat analogue product, which may contain additional ingredients as set forth below.

In some embodiments, the meat-like product is a meat analogue product, which is a product intended to replace or substitute meat or dairy products, and which often rely on various non-animal-based materials, such as starches, fiber, and proteins derived from plants, algae, and fungi, to simulate the texture and flavor of meat or dairy. Non-limiting examples of such plant proteins used in such products include soy proteins, pea proteins, bean proteins, grain proteins, and the like. Due to compositional differences between such plant-based materials and animal-derived materials, such as a lack of glutamate-containing proteins and glutathione, these products can lack the umami and/or kokumi taste that consumers traditionally associate with meat or dairy products.

Thus, in certain aspects, the disclosure provides a meat analogue product comprising a plant-based material (such as a plant-based starch, a plant-based protein, or a combination thereof) and an gingerdiol flavor-modifying compound (according to any aspects and embodiments set forth herein). In some embodiments, the meat analogue product is a particular meat-replacement product, such as a plant-based chicken product (such as a plant-based chicken nugget), a plant-based beef product (such as a plant-based burger), and the like. In some other embodiments, the flavored product is a protein powder, a meal-replacement powder, a plant-based creamer for coffee or tea, and the like. In certain further embodiments, any such products contain additional ingredients, and have additional features, as are typically used in the preparation or manufacture of such products. For example, such a gingerdiol flavor-modifying compound may be combined with other flavors and taste modifiers, and may even be encapsulated in certain materials, according to known technologies in the relevant art. In some further embodiments analogous to the above embodiments, proteins or starches from algal or fungal sources can be used instead of or in combination with plant starches or proteins.

For example, the gingerdiol flavor-modifying compounds can be introduced into the flavored emulsions described in PCT Publication No. WO 2020/260628. Further, the gingerdiol flavor-modifying compounds can be introduced into any of the embodiments of PCT Application No. PCT/EP2020/081588 (to be published in May 2021).

In some embodiments, the meat-like product comprises one or more non-animal proteins. In some embodiments, the non-animal proteins are mycoproteins, algal proteins, plant proteins, or any combinations thereof. In some embodiments, the meat-like product comprises plant protein, such as pea protein, soy protein, almond protein, cashew protein, canola (rapeseed) protein, chickpea protein, fava protein, sunflower protein, wheat protein, oat protein, potato protein, and the like.

In some embodiments, the meat-like product comprises one or more plant fibers, such as citrus fiber, pea fiber, potato fiber, psyllium fiber, chicory fiber (inulin), nut fiber, grain fiber, rice fiber, seed fiber, oat fiber, berry fiber, soybean fiber, banana fiber, apple fiber, carrot fiber, and the like.

The gingerdiol flavor-modifying compounds can be used in the meat-like products in any suitable concentration. For example, in some embodiments, the meat-like products contain the gingerdiol flavor-modifying compounds at concentrations ranging from 0.1 ppm to 500 ppm, or from 0.1 ppm to 200 ppm, or from 0.1 ppm to 100 ppm, or from 0.1 ppm to 90 ppm, or from 0.1 ppm to 80 ppm, or from 0.1 ppm to 70 ppm, or from 0.1 ppm to 60 ppm, or from 0.1 ppm to 50 ppm, or from 0.1 ppm to 40 ppm, or from 0.1 ppm to 30 ppm, or from 0.1 ppm to 20 ppm, or from 0.1 ppm to 10 ppm, or from 0.1 ppm to 5 ppm, or from 0.1 ppm to 2 ppm, or from 0.1 ppm to 1 ppm.

### Non-Alcoholic or Low-Alcoholic Products

In certain aspects, the disclosure provides comestible products, such as low-alcohol or alcohol-free beverages, that contain gingerdiol flavor-modifying compounds according to any of the embodiments set forth above. In general, such beverages principally comprise water. In some embodiments, the beverages further comprise carbon dioxide, for example, at typical concentrations for carbonated beverages. In some embodiments, the beverages further contain typical preservatives and excipients commonly used in beverages. In some embodiments, the beverage comprise a flavoring, such as described in further detail below. The gingerdiol flavor-modifying compounds can be used in the beverages in any suitable concentration. For example, in some embodiments, the beverages contain the gingerdiol flavor-modifying compounds at concentrations ranging from 0.1 ppm to 500 ppm, or from 0.1 ppm to 200 ppm, or from 0.1 ppm to 100 ppm, or from 0.1 ppm to 90 ppm, or from 0.1 ppm to 80 ppm, or from 0.1 ppm to 70 ppm, or from 0.1 ppm to 60 ppm, or from 0.1 ppm to 50 ppm, or from 0.1 ppm to 40 ppm, or from 0.1 ppm to 30 ppm, or from 0.1 ppm to 20 ppm, or from 0.1 ppm to 10 ppm, or from 0.1 ppm to 5 ppm, or from 0.1 ppm to 2 ppm, or from 0.1 ppm to 1 ppm. In some embodiments, the beverages are free of alcohol. In other embodiments, the beverages comprise alcohol at any suitable concentration. In some embodiments, the alcohol content ranges from 0.5% (by volume) to 7.0% (by volume), or from 0.5% (by volume) to 6.0% (by volume), or from 0.5% (by volume) to 5.0% (by volume), or from 0.5% (by volume) to 4.0% (by volume), or from 0.5% (by volume) to 3.0% (by volume), or from 0.5% (by volume) to 2.0% (by volume), or from 0.5% (by volume) to 1.0% (by volume).

In certain other aspects, the disclosure provides comestible products, such as confectionary or candy products, that contain gingerdiol flavor-modifying compounds according to any of the embodiments set forth above. In some embodiments, the confectionary or candy products contain typical preservatives and excipients commonly used in beverages. In some embodiments, the confectionary or candy products comprise a flavoring, such as described in further detail below. The gingerdiol flavor-modifying compounds can be used in the confectionary or candy products in any suitable concentration. For example, in some embodiments, the beverages contain the gingerdiol flavor-modifying compounds at concentrations ranging from 1 ppm to 500 ppm, or from 1 ppm to 200 ppm, or from 1 ppm to 100 ppm, or from 1 ppm to 90 ppm, or from 1 ppm to 80 ppm, or from 1 ppm to 70 ppm, or from 1 ppm to 60 ppm, or from 1 ppm to 50 ppm, or from 1 ppm to 40 ppm, or from 1 ppm to 30 ppm, or from 1 ppm to 20 ppm, or from 1 ppm to 10 ppm. In some embodiments, the confectionary or candy products are free of alcohol. In other embodiments, the confectionary or candy products comprise alcohol at any suitable concentration.

### Additional Ingredients

The comestible products set forth above (meat-like products, beverages, confectionary products, and candy products) can contain any number of additional ingredients, as are commonly included in food and beverage products.

In some embodiments, the comestible products set forth comprise one or more sweeteners. For example, in some embodiments, the sweetener (according to any of the embodiments set forth above) is present in an amount from about 0.1% to about 12% by weight. In some embodiments, the sweetener is present in an amount from about 0.2% to about 10% by weight. In some embodiments, the sweetener is present in an amount from about 0.3% to about 8% by weight. In some embodiments, the sweetener is present in an amount from about 0.4% to about 6% by weight. In some embodiments, the sweetener is present in an amount from about 0.5% to about 5% by weight. In some embodiments, the sweetener is present in an amount from about 1% to about 2% by weight. In some embodiments, the sweetener is present in an amount from about 0.1% to about 5% by weight. In some embodiments, the sweetener is present in an amount from about 0.1% to about 4% by weight. In some embodiments, the sweetener is present in an amount from about 0.1% to about 3% by weight. In some embodiments, the sweetener is present in an amount from about 0.1% to about 2% by weight. In some embodiments, the sweetener is present in an amount from about 0.1% to about 1% by weight. In some embodiments, the sweetener is present in an amount from about 0.1% to about 0.5% by weight. In some embodiments, the sweetener is present in an amount from about 0.5% to about 10% by weight. In some embodiments, the sweetener is present in an amount from about 2% to about 8% by weight. In some further embodiments of the embodiments set forth in this paragraph, the sweetener is sucrose, fructose, glucose, xylitol, erythritol, or combinations thereof.

In some other embodiments, the sweetener is present in an amount from 10 ppm to 1000 ppm. In some embodiments, the sweetener is present in an amount from 20 ppm to 800 ppm. In some embodiments, the sweetener is present in an amount from 30 ppm to 600 ppm. In some embodiments, the sweetener is present in an amount from 40 ppm to 500 ppm. In some embodiments, the sweetener is present in an amount from 50 ppm to 400 ppm. In some embodiments, the sweetener is present in an amount from 50 ppm to 300 ppm. In some embodiments, the sweetener is present in an amount from 50 ppm to 200 ppm. In some embodiments, the sweetener is present in an amount from 50 ppm to 150 ppm. In some further embodiments of the embodiments set forth in this paragraph, the sweetener is a steviol glycoside, a mogroside, a derivative of either of the foregoing, such as glycoside derivatives (e.g., glucosylates), or any combination thereof.

The comestible products can include any suitable sweeteners or combination of sweeteners. In some embodiments, the sweetener is a common saccharide sweeteners, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the sweetener is a combination of two or more of the sweeteners set forth in this paragraph. In some embodiments, the sweetener may combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar may be sucrose. In some embodiments, the sugar may be a combination of fructose and glucose.

The sweetener can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green Stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet Stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

Additional sweeteners also include combinations of any two or more of any of the aforementioned sweeteners. In some embodiments, the sweetener may comprise combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a caloric sweetener, such as sucrose, fructose, xylitol, erythritol, or combinations thereof. In some embodiments, the ingestible compositions are free (or, in some embodiments) substantially free of Stevia-derived sweeteners, such as steviol glycosides, glucosylated steviol glycosides, or rebaudiosides. For example, in some embodiments, the ingestible compositions are either free of Stevia-derived sweeteners or comprise Stevia-derived sweeteners in a concentration of no more than 1000 ppm, or no more than 500 ppm, or no more than 200 ppm, or no more than 100 ppm, or no more than 50 ppm, or no more than 20 ppm, or no more than 10 ppm, or no more than 5 ppm, or no more than 3 ppm, or no more than 1 ppm.

The comestible products can, in certain embodiments, comprise any additional ingredients or combination of ingredients as are commonly used in food and beverage products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, Panax ginseng extract, guanana extract, ginger extract, L-phenylalanine, L-carnitine, L-tartrate, D-glucoronolactone, inositol, bioflavonoids, Echinacea, Ginko biloba, yerba mate, flax seed oil, Garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;
clouding agents, including, for example ester gun, brominated vegetable oil (BVO), or sucrose acetate isobutyrate (SAIB);
buffers, including, for example sodium citrate, potassium citrate, or salt;
flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or
starches and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), inulin, or carrageenan.

The comestible products can have any suitable pH. In some embodiments, the gingerdiol compounds enhance the sweetness of a sweetener under a broad range of pH, e.g., from lower pH to neutral pH. The lower and neutral pH includes, but is not limited to, a pH from 1.5 to 9.0, or from 2.5 to 8.5; from 3.0 to 8.0; from 3.5 to 7.5; and from 4.0 to 7. In certain embodiments, compounds as disclosed and described herein, individually or in combination, can enhance the perceived sweetness of a fixed concentration of a sweetener in taste tests at a compound concentration of 50 μM, 40 μM, 30 μM, 20 μM, or 10 μM at both low to neutral pH value. In certain embodiments, the enhancement factor of the compounds as disclosed and described herein, individually or in combination, at the lower pH is substantially similar to the enhancement factor of the compounds at neutral pH. Such consistent sweet enhancing property under a broad range of pH allow a broad use in a wide variety of foods and beverages of the compounds as disclosed and described herein, individually or in combination.

The comestible products set forth according to any of the foregoing embodiments, also include, in certain embodiments, one or more additional flavor-modifying compounds, such as compounds that enhance sweetness (e.g., hesperetin, naringenin, glucosylated steviol glycosides, etc.), compounds that block bitterness, compounds that enhance umami, compounds that reduce sourness or licorice taste, compounds that enhance saltiness, compounds that enhance a cooling effect, or any combinations of the foregoing.

Any salt that imparts a salty taste may be present or incorporated into a food product that contains a bioactive, taste modulating, or salty taste modulating compound of the present invention. The most commonly used salt for food applications is sodium chloride. Other illustrative sources of sodium salts that may be present of incorporated into a food product include sodium phosphates, mono sodium glutamate, sodium nitrite, sodium nitrate, sodium bicarbonate, sodium lactate, sodium citrate, and sodium stearoyl lactylate. Similar lithium, potassium, ammonium or other alkali earth salts may be present or included in addition or as an alternative to one or more sodium salts.

Thus, in some embodiments, the comestible products disclosed herein comprise a gingerdiol flavor-modifying compound, according to any of the embodiments or combination of embodiments set forth above, and one or more sweetness enhancing compounds. Such sweetness enhancing compounds include, but are not limited to, naturally derived compounds, such as hesperitin, naringenin, rhoifolin, glucosylated steviol glycosides, licorice-derived glucuronates, aromadendrin-3-O-acetate, or other like flavonols, or flavonoids, or synthetic compounds, such as any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. The gingerdiol compounds (or comestibly acceptable salts thereof) may be used in combination with such other sweetness enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1. In some embodiments of any of the preceding embodiments, the gingerdiol compound (or any comestibly acceptable salts thereof) is combined with glucosylated steviol glycosides in any of the above ratios. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth. In some embodiments of any of the preceding embodiments, the gingerdiol compound (or any comestibly acceptable salts thereof) is combined with 3-((4-amino-2,2-dioxo-1H-benzo[c][1,2,6]thiadiazin-5-yl)oxy)-2,2-dimethyl-N-propyl-propanamide, N-(1-((4-amino-2,2-dioxo-1H-benzo[c][1,2,6]thiadiazin-5-yl)oxy)-2-methyl-propan-2-yl)isonicotinamide, or any combination thereof, in any of the above ratios.

In some further embodiments, the comestible products disclosed herein comprise a gingerdiol flavor-modifying compound, according to any of the embodiments or combination of embodiments set forth above, and one or more other umami or kokumi enhancing compounds. Such umami enhancing compounds include, but are not limited to, naturally derived compounds, such as ericamide, or synthetic compounds, such as any compounds set forth in U.S. Pat. Nos. 8,735,081; 8,124,121; and 8,968,708. The gingerdiol compound (or comestibly acceptable salts thereof) may be used in combination with such umami enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1,20:1,21:1,22:1,23:1,24:1, or 25:1.

In some further embodiments, the comestible products disclosed herein comprise a gingerdiol flavor-modifying compound, according to any of the embodiments or combination of embodiments set forth above, and one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727. The gingerdiol compound (or comestibly acceptable salts thereof) may be used in combination with such umami enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some further embodiments, the comestible products disclosed herein comprise a gingerdiol flavor-modifying compound, according to any of the embodiments or combination of embodiments set forth above, and one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759. The gingerdiol compound (or comestibly acceptable salts thereof) may be used in combination with such bitterness blockers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1,20:1,21:1,22:1,23:1, 24:1, or 25:1.

In some further embodiments, the comestible products disclosed herein comprise a gingerdiol flavor-modifying compound, according to any of the embodiments or combination of embodiments set forth above, and one or more sour taste modulating compounds. The gingerdiol compound (or comestibly acceptable salts thereof) may be used in combination with such sour taste modulating compounds in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1,20:1,21:1,22:1,23:1,24:1, or 25:1.

In some further embodiments, the comestible products disclosed herein comprise a gingerdiol flavor-modifying compound, according to any of the embodiments or combination of embodiments set forth above, and one or more mouthfeel modifying compounds. Such mouthfeel modifying compounds include, but are not limited to, tannins, cellulosic materials, bamboo powder, and the like. The gingerdiol compound (or comestibly acceptable salts thereof) may be used in combination with such mouthfeel enhancers in any suitable ratio (w/w) ranging from 1:1000 to 1000:1, or from 1:100 to 100:1, or fro, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In some further embodiments, the comestible products disclosed herein comprise a gingerdiol flavor-modifying compound, according to any of the embodiments or combination of embodiments set forth above, and one or more flavor masking compounds. Such flavor masking compounds include, but are not limited to, cellulosic materials, materials extracted from fungus, materials extracted from plants, citric acid, carbonic acid (or carbonates), and the like. The gingerdiol compound (or comestibly acceptable salts thereof) may be used in combination with such mouthfeel enhancers in any suitable ratio (w/w) ranging from 1:1000 to 1000:1, or from 1:100 to 100:1, or from, 1:50 to 50:1, or from 1:25 to 25:1, or from 1:10 to 10:1, such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1,20:1,21:1,22:1,23:1,24:1, or 25:1.

In some embodiments, the comestible products disclosed above can contain a carrier or adjuvants. The term “carrier” denotes a usually inactive accessory substance, such as solvents, binders, or other inert medium, which is used in combination with the present compound and one or more optional adjuvants to form the formulation. For example, water or starch can be a carrier for a flavoring concentrate formulation. In some embodiments, the carrier is the same as the diluting medium for reconstituting the flavoring concentrate formulation; and in other embodiments, the carrier is different from the diluting medium. The term “carrier” as used herein includes, but is not limited to, ingestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more sweeteners. The one or more sweeteners can be any of the sweeteners described in this application. In another embodiment, the at least one adjuvant comprises one or more ingredients selected from the group consisting of a emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described, and claimed herein. The reader will recognize that the skilled artisan, armed with the present disclosure, and skill in the art is able to prepare and use the invention without exhaustive examples.

### Example 1—Sensory Testing Wit Salt Reduction

Sensory testing was carried out using a panel of four (4) expert tasters, who rated the taste of the a mushroom-based cream soup with: (a) a normal amount of salt (0.855%); (b) 20% reduced salt (0.684%); and (c) 20% reduced salt (0.684%) with 1 ppm [6]-gingerdiol-diacetate. The panelists rated the soups for salt intensity, umami intensity, bitter intensity, and overall liking on a scale from 1 to 10. The results are shown in Table 1.

TABLE 1

| | Saltiness | Umami | Bitter | Overall Liking |
|---|---|---|---|---|
| Reg. Salt | 5.8 | 4.8 | 0.0 | 6.3 |
| Red. Salt | 3.0 | 3.0 | 0.3 | 3.3 |
| Red. Salt + | 3.3 | 3.0 | 0.0 | 2.3 |
| Gingerdiol | | | | |

Further sensory testing was carried out using a panel of three (3) expert tasters, who rated the taste of a meat flavoring formulation with: (a) a normal amount of salt (0.821%); (b) 20% reduced salt (0.646%); and (c) 20% reduced salt (0.646%) with 1 ppm [6]-gingerdiol-diacetate. The panelists rated the soups for salt intensity, umami intensity, bitter intensity, and overall liking on a scale from 1 to 10. The results are shown in Table 2.

TABLE 2

| | Saltiness | Umami | Bitter | Overall Liking |
|---|---|---|---|---|
| Reg. Salt | 6.0 | 3.3 | 3.0 | 5.0 |
| Red. Salt | 5.7 | 3.3 | 2.3 | 5.3 |
| Red. Salt + | 5.3 | 4.0 | 2.3 | 5.0 |
| Gingerdiol | | | | |

1. A method to enhance a salty taste, enhance an umami taste, enhance a kokumi taste, enhance perceived juiciness, or enhance perceived fattiness, of a meat-like product, the method comprising introducing a flavor-modifying compound to the meat-like product, wherein the flavor-modifying compound is a compound of formula (I) 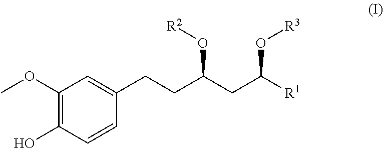
or a comestibly acceptable salt thereof,
wherein:
R¹ is C₁₋₁₂ alkyl; and
R² and R³ are, independently from each other, a hydrogen atom, —C(O)—H, or —C(O)—(C₁₋₆ alkyl);
wherein the meat-like product comprises a non-animal protein a comprises no more than 0.1 percent by weight animal products.

2. The method of claim 1, wherein R¹ is pentyl.

3. The method of claim 1, wherein R² and R³ are —C(O)—CH₃.

4. The method of claim 1, wherein the meat-like product comprises mushrooms.

5. The method of claim 1, wherein the meat-like product is a meat analogue.

6. (canceled)

7. The method of claim 5, wherein the meat analogue comprises a meat flavoring.

8. The method of claim 1, wherein the non-animal protein is a mycrprotein, an algal protein, a plant protein, or any combination thereof.

9. The method of claim 8, wherein the non-animal protein is a plant protein.

10. The method of claim 9, wherein the plant protein is pea protein.

11. The method of claim 1, wherein the meat-like product comprises a plant fiber.

12. A method to enhance a perceived alcohol content of a beverage product, the method comprising introducing a flavor-modifying compound to the beverage product, wherein the flavor-modifying compound is a compound of formula (I) 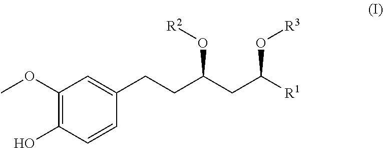
or a comestibly acceptable salt thereof,
wherein:
R¹ is C₁₋₁₂ alkyl; and
R² and R³ are, independently from each other, a hydrogen atom, —C(O)—H, or —C(O)—(C₁₋₆ alkyl).

13. The method of claim 12, wherein R¹ is pentyl.

14. The method of claim 12, wherein R² and R³ are —C(O)—CH₃.

15. The method of claim 12, wherein the beverage product comprises no more than 5.0 percent by volume ethanol.
